(19) United States
(12) Patent Application Publication
(10) Pub. No.: US 2014/0287686 A1
(43) Pub. Date: Sep. 25, 2014

(54) PAIRING METHOD BETWEEN ELECTRONIC DEVICES INCLUDING COMMUNICATION FUNCTION AND ELECTRONIC DEVICE

(71) Applicant: CASIO COMPUTER CO., LTD., Tokyo (JP)

(72) Inventor: Katsuya KOBAYASHI, Tokyo (JP)

(73) Assignee: CASIO COMPUTER CO., LTD., Tokyo (JP)

(21) Appl. No.: 14/219,942

(22) Filed: Mar. 19, 2014

(30) Foreign Application Priority Data
Mar. 22, 2013 (JP) 2013-060155

(51) Int. Cl. H04W 76/02; H04W 4/00

(52) U.S. Cl. CPC H04W 76/023; H04W 4/008
USPC 455/41.2

(57) ABSTRACT

Disclosed is a pairing method which pairs electronic devices. Each electronic device includes a communication unit to communicate data and a light receiving unit to detect receiving light amount. The method includes the following. The electronic devices are set to a pairing standby state. Light intensity on the light receiving units is changed under a same light receiving environment. Time series data of receiving light amount detected by the light receiving unit of a second electronic device is transmitted from the second electronic device to a first electronic device. The electronic devices are paired based on time series data of receiving light amount detected by the receiving light units.

### BACKGROUND OF THE INVENTION

1. Field of the Invention

The present invention relates to a pairing method between electronic devices including a communication function and an electronic device.

2. Description of the Related Art

Lately, methods to transmit and receive various types of data among electronic devices including wireless communication functions such as Bluetooth (registered trademark) are spreading, and there are methods such as exchanging data or synchronizing information wirelessly.

Such data transmitted and received by wireless communication may include much personal information. Therefore, in order to protect privacy, it is necessary to accurately communicate data from one specific electronic device to another specific electronic device.

In order to suitably pair the electronic devices with which the user desires to establish communication (in other words, initial recognition operation), for example, Japanese Patent Application Laid-Open Publication No. 2011-199381 proposes a wireless communication apparatus which predicts a distance between another apparatus based on ultrasound signals emitted from another apparatus and when the distance between the apparatus is within a predetermined range, a connection request describing the pairing information is transmitted to establish short distance wireless communication.

However, when the electronic devices are paired, there is a possibility that the device may be paired with electronic devices with which the user does not desire linkage when there are a plurality of electronic devices within the accessible area of the radio wave emitted from the electronic device.

There is also a method to set the password of the electronic devices with which the user desires to establish communication to be the same so as to define the communication partner. However, there is a problem that pairing using such methods requires much trouble.

It is predicted that electronic devices including wireless communication functions will continue to increase. However, according to conventional pairing methods, operation is complicated and such operation may be difficult for unaccustomed users.

### SUMMARY OF THE INVENTION

The present invention has been conceived in view of the above problems, and one of the main objects is to perform pairing between specific electronic devices by an easy method.

According to an aspect of the present invention, there is provided a pairing method which pairs a first electronic device with a second electronic device, each electronic device including a communication unit to communicate data and a light receiving unit to detect receiving light amount, the method including:

setting the first electronic device and the second electronic device to a pairing standby state;

changing light intensity on the light receiving unit of the first electronic device and the light receiving unit of the second electronic device under a same light receiving environment;

transmitting from the second electronic device to the first electronic device time series data of receiving light amount detected by the light receiving unit of the second electronic device in the changing of the light intensity; and

pairing the first electronic device with the second electronic device based on time series data of receiving light amount detected by the receiving light unit of the first electronic device in the changing of the light intensity and the time series data of receiving light amount transmitted from the second electronic device.

According to an aspect of the present invention, there is provided an electronic device including:

a communication unit which communicates data;

a light receiving unit which detects receiving light amount;

an obtaining unit which obtains from another electronic device time series data of receiving light amount detected in another electronic device at a same timing as detecting the receiving light amount with the light receiving unit; and

a pairing unit which pairs the electronic device with another electronic device based on time series data of receiving light amount detected by the light receiving unit and the time series data of receiving light amount obtained by the obtaining unit.

### BRIEF DESCRIPTION OF THE DRAWINGS

The present invention and the above-described objects, features and advantages thereof will become more fully understood from the following detailed description with the accompanying drawings and wherein;

FIG. 1 is an entire configuration diagram showing a wireless communication system;

FIG. 2 is a block diagram showing an internal configuration of a cellular phone;

FIG. 3 is a block diagram showing an internal configuration of an electronic timepiece;

FIG. 4 is a ladder chart showing pairing processing performed in the wireless communication system;

FIG. 5 is a flowchart showing electric current data increase/decrease pattern analysis processing performed in the cellular phone;

FIG. 6 is an example of electric current data obtained from a cellular phone and electric current data obtained from an electronic timepiece;

FIG. 7 is an example considered to not have the same pattern change between electric current data obtained from the cellular phone and electric current data obtained from an electronic timepiece; and

FIG. 8 is a flowchart showing pairing processing performed in a cellular phone.

### DETAILED DESCRIPTION OF THE PREFERRED EMBODIMENTS

An embodiment of the pairing method between electronic devices according to the present invention is described below with reference to the drawings. The present invention is not limited to the illustrated examples.

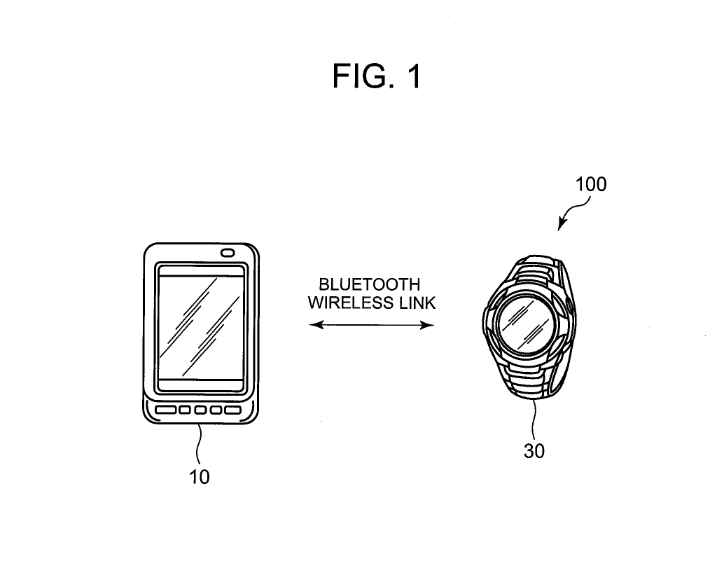

FIG. 1 is a diagram of an entire configuration of a wireless communication system 100.

The wireless communication system 100 includes, a cellular phone 10 as a first electronic device, and an electronic timepiece 30 as a second electronic device.

The electronic timepiece 30 includes a timepiece main body and a band, and is a watch type timepiece which can be attached to an arm.

Both the cellular phone 10 and the electronic timepiece 30 include a short distance wireless communication function, and are able to communicate with each other by Bluetooth communication.

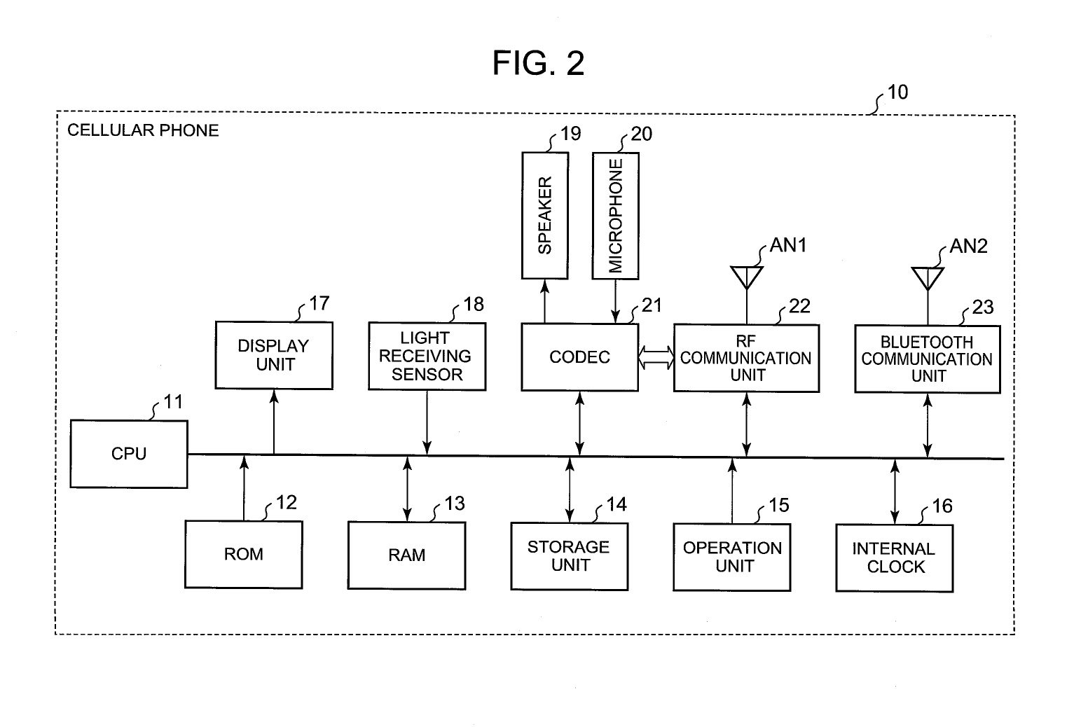

FIG. 2 is a block diagram showing an internal configuration of a cellular phone 10.

As shown in FIG. 2, the cellular phone 10 includes, a CPU (Central Processing Unit) 11 as an obtaining unit and a pairing unit, a ROM (Read Only Memory) 12, a RAM (Random Access Memory) 13, a storage unit 14, an operation unit 15, an internal clock 16, a display unit 17, a light receiving sensor 18 as a light receiving unit, a speaker 19, a microphone 20, a codec 21, an RF communication unit 22, and a Bluetooth communication unit 23 as a communication unit.

The CPU 11 centrally controls the entire operation of the cellular phone 10 and executes various computing processing. Specifically, the CPU 11 reads various processing programs stored in the ROM 12 to be expanded in the RAM 13 and performs various processing in coordination with such programs.

The ROM 12 is a semiconductor memory exclusive for readout, and stores various programs executed by the CPU 11 and various pieces of data.

The RAM 13 provides a workspace in the memory for the CPU 11 and stores temporary data for the job.

The storage unit 14 includes a nonvolatile memory and stores the information so as to be readable and writable.

For example, the storage unit 14 stores various application programs executed by the cellular phone 10 and saved data and setting data regarding the various functions.

The operation unit 15 includes various buttons, etc. for receiving input operation by the user and outputs the operation signal based on the operation by the user to the CPU 11.

The operation unit 15 includes a touch panel provided on a display screen of the display unit 17. The operation section 15 detects the position touched by the user's finger, etc., and outputs the operation signal according to the position to the CPU 11.

The internal clock 16 is a counter which counts and holds the present time.

Present time data of the internal clock 16 is corrected as needed when the RF communication unit communicates with a base station.

The display unit 17 includes an LCD (Liquid Crystal Display), and displays a screen according to a display control signal from the CPU 11.

The display unit 17 displays results of various processing executed by the cellular phone 10, information showing whether pairing succeeded, and the like.

The light receiving sensor 18 is an element which executes photoelectric conversion and outputs an electric current according to receiving light amount (intensity of the received light).

The light receiving sensor 18 functions as a light receiving unit which detects receiving light amount.

The light receiving sensor 18 is provided on a face which faces the user during use of the cellular phone 10, such as the face provided with the display unit 17 of the portable phone 10.

The speaker 19 converts an electric signal based on a signal from the codec 21 to an audio signal and outputs the audio.

The microphone 20 detects a sound wave and converts the sound wave to an electric signal. Then, the signal is output to the codec 21.

The codec 21 decodes an encoded and compressed digital audio signal and transmits the signal as an analog signal to the speaker 19. The codec 21 also encodes an audio signal output from the microphone 20 and outputs the signal to the CPU 11 or the RF communication unit 22.

The RF communication unit 22 executes processing regarding transmitting and receiving packet data such as telephone audio data, electronic mail, etc. between the base station using an antenna AN1 for RF transmission and reception, and receives and transmits data between the CPU 11 and codec 21.

The Bluetooth communication unit 23 performs data communication by Bluetooth communication format with other electronic devices such as the electronic timepiece 30 through an antenna AN 2 for transmission and reception of Bluetooth communication.

The Bluetooth communication unit 23 can employ a format of Bluetooth communication for low energy consumption (Bluetooth Low Energy).

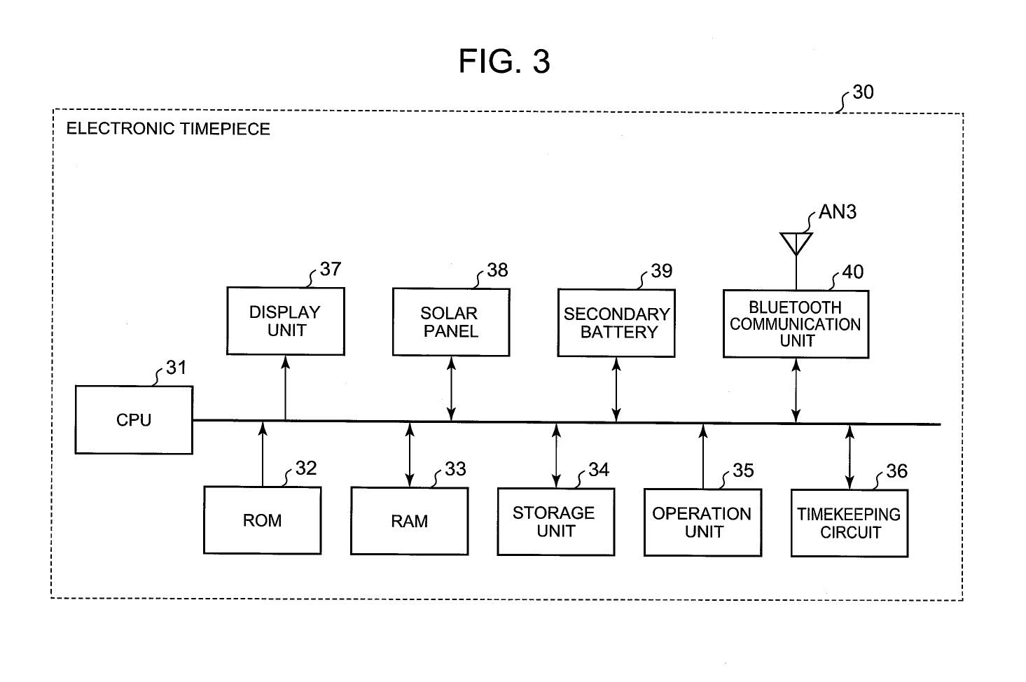

FIG. 3 is a block diagram showing an internal configuration of an electronic timepiece 30.

As shown in FIG. 3, the electronic timepiece 30 includes a CPU 31, a ROM 32, a RAM 33, a storage unit 34, an operation unit 35, a timekeeping circuit 36, a display unit 37, a solar panel 38 as a light receiving unit, a secondary battery 39, and a Bluetooth communication unit 40 as the communication unit.

The CPU 31 centrally controls the entire operation of the electronic timepiece 30 and executes various computing processing.

Specifically, the CPU 31 reads various processing programs stored in the ROM 32 to be expanded in the RAM 33 and performs various processing in coordination with such programs.

The CPU 31 allows the display unit 37 to display the time according to the present time counted by the timekeeping circuit 36.

The ROM 32 is a semiconductor memory exclusive for readout, and stores various programs executed by the CPU 31 and various pieces of data.

The RAM 33 provides a workspace in the memory for the CPU 31 and stores temporary data for the job.

The storage unit 34 includes a nonvolatile memory and stores the information so as to be readable and writable.

The operation unit 35 includes one or a plurality of button switches and outputs operation signals according to the operation of the switch operated by the user to the CPU 31.

The timekeeping circuit 36 is a counter which counts and holds the present time.

The counter can be a RAM which simply stores information of the present time.

The display unit 37 includes an LCD of a dot-matrix display format, or the like.

The display unit 37 displays the present time, a setting state, information of whether pairing succeeded and the like.

The electronic timepiece 30 can be an analog type, and the display unit 37 can include a dial face provided with a scale and a plurality of hands which rotate above the dial face.

The solar panel 38 generates electricity with light from outside, and outputs electric current generated according to the receiving light amount (intensity of the received light).

The solar panel 38 functions as a light receiving unit which detects receiving light amount.

The solar panel 38 is provided on a display face, etc. of the display unit 37 of the electronic timepiece 30.

The secondary battery 39 receives input of the electric current generated by the solar panel 38 and accumulates the electric current. The secondary battery 39 supplies the electric power to each section.

The Bluetooth communication unit 40 performs data communication by Bluetooth communication format with other electronic devices such as the cellular phone 10, etc. through an antenna AN 3 for transmission and reception of Bluetooth communication.

Next, the operation of the wireless communication system 100 is described.

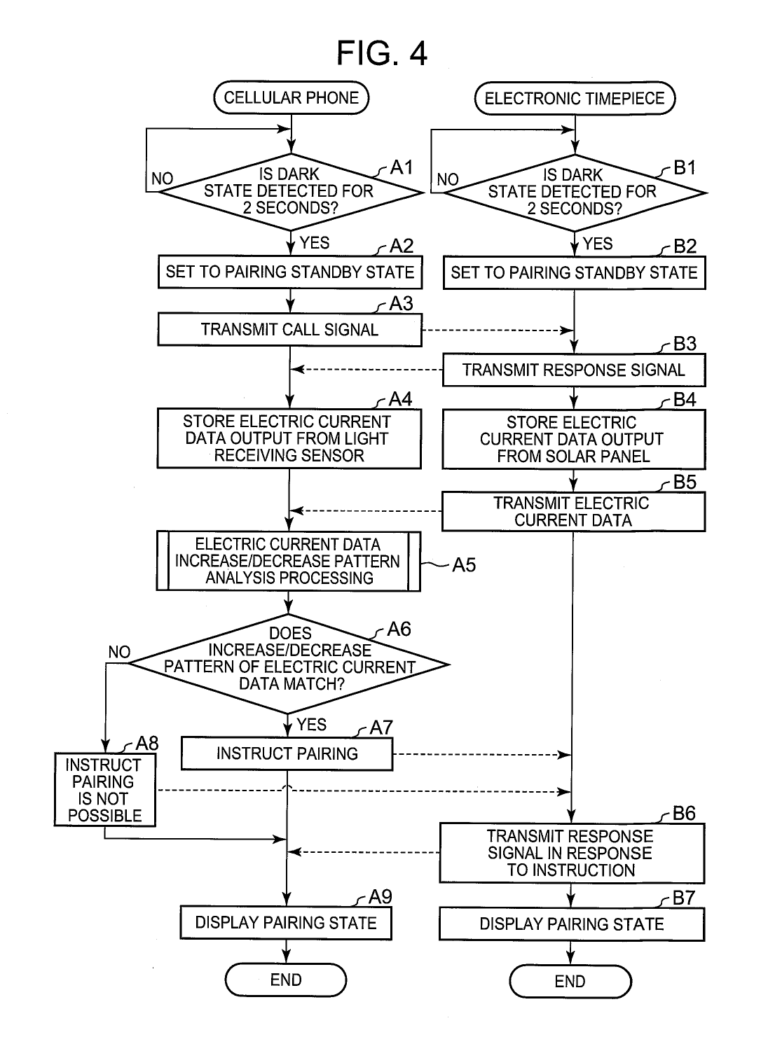

FIG. 4 is a ladder chart showing the pairing processing executed in the cellular phone 10 and the electronic timepiece 30 of the wireless communication system 100.

### [First Step]

First, the cellular phone 10 and the electronic timepiece 30 which are to be paired are placed adjacent to each other under the same light source.

Here, the light receiving sensor 18 of the cellular phone 10 and the solar panel 38 of the electronic timepiece 30 face upward.

The distance between the cellular phone 10 and the electronic timepiece 30 is a distance so that the environment of the light received is similar between the devices when the user moves the palm of the hand above both devices.

The light source can be an interior light or sunlight.

Next, the user provides a predetermined light receiving environment condition to the light receiving sensor 18 of the cellular phone 18 and the solar panel 38 of the electronic timepiece 30.

In the present embodiment, a shielding state (dark state) of two seconds is employed as the predetermined light receiving environment condition to trigger the start of the pairing mode.

For example, the user shields the light receiving sensor 18 of the cellular phone 10 with the palm of the left hand for two seconds or more while the user shields the solar panel 38 of the electronic timepiece 30 with the palm of the right hand for two seconds or more.

Here, it is preferable that the light receiving sensor 18 and the solar panel 38 are covered by the hands to prevent the light entering the light receiving sensor 18 and the solar panel 38 as much as possible.

In the cellular phone 10, the CPU 11 obtains time series data of the electric current value (electric current data) corresponding to the receiving light amount detected by the light receiving sensor 18, and judges whether the state where the light receiving sensor 18 is shielded (dark state) continues for two seconds (step A1).

Specifically, the CPU 11 judges whether the state that the electric current value included in the electric current data is a predetermined threshold or less continues for two seconds.

When the state that the light receiving sensor 18 is shielded continues for two seconds (step A1; YES), the CPU 11 sets the cellular phone 10 to a pairing standby state (step A2).

The pairing standby state is a state on standby for setting a communication partner to communicate by Bluetooth communication.

Similarly, in the electronic timepiece 30, the CPU 31 obtains the time series data of the electric current value (electric current data) corresponding to the receiving light amount detected by the solar panel 38, and judges whether a state that the solar panel 38 is shielded (dark state) continues for two seconds (step B1).

When the state that the solar panel 38 is shielded continues for two seconds (step B1; YES), the CPU 31 sets the electronic timepiece 30 to the pairing standby state (step B2).

When the cellular phone 10 is in a pairing standby state, the CPU 11 transmits a call signal through the Bluetooth communication unit 23 to detect a device that can be paired (step A3).

In the electronic timepiece 30, when the Bluetooth communication unit 40 receives the call signal from the cellular phone 10, the CPU 31 transmits through the Bluetooth communication unit 40 a response signal to the cellular phone 10 (step B3).

### [Second Step]

Next, the user successively changes the light intensity received by the light receiving sensor 18 of the cellular phone 10 and the solar panel 38 of the electronic timepiece 30 under the same light receiving environment.

For example, the user moves the palm of the hand back and forth so as to pass above the light receiving sensor 18 of the cellular phone 10 and the solar panel 38 of the electronic timepiece 30 a plurality of times.

In other words, the user moves the palm of the hand back and forth so as to cross above the light receiving portion of the light receiving sensor 18 and the solar panel 38 a plurality of times to intermittently shield the light received by the light receiving sensor 18 and the solar panel 38.

The user moves the palm of the hand positioning the hand close enough to the light receiving sensor 18 and the solar panel 38 so that the receiving light amount of the light receiving sensor 18 and the solar panel 38 substantially changes.

Moreover, the user needs to move the palm of the hand so that the movement of the palm of the hand is substantially the same speed for each of the light receiving sensor 18 and the solar panel 38.

When the palm of the hand is in a position which shields light from the light source to the light receiving sensor 18 and the solar panel 38, the receiving light amount of the light receiving sensor 18 and the solar panel 38 reduces.

In other words, when the palm of the hand passes above the light receiving sensor 18 and the solar panel 38 once, the receiving light amount of the light receiving sensor 18 and the solar panel 38 reduces temporarily and then increases.

When the palm of the hand comes and goes once, the receiving light amount of the light receiving sensor 18 and the solar panel 38 reduces and increases twice respectively.

In the cellular phone 10, the CPU 11 stores in the storage unit 14 the time series data of the electric current value (electric current data) corresponding to the receiving light amount detected by the light receiving sensor 18 for a predetermined term after the response signal is received from the electronic timepiece 30 (step A4).

The electric current data of the cellular phone 10 is data where the electric current value output from the light receiving sensor 18 is corresponded to the present time output from the internal clock 16 and the above is stored according to the time.

In the electronic timepiece 30, the CPU 31 stores in the storage unit 34 the time series data of the electric current value (electric current data) corresponding to the receiving light amount detected by the solar panel 38 for a predetermined term after the response signal is transmitted to the cellular phone 10 (step B4).

The electric current data of the electronic timepiece 30 is data where the electric current value output from the solar panel 38 is corresponded to the present time output from the timekeeping circuit 36, and the above is stored according to the time.

The predetermined term that the electric current data is stored in the cellular phone 10 and the electronic timepiece 30 includes a time range that the intensity of light received by the light receiving sensor 18 and the solar panel 38 changes due to the motion by the user.

### [Third Step]

Next, in the electronic timepiece 30, the CPU 31 transmits the electric current data stored in step B4 through the Bluetooth communication unit 40 to the cellular phone 10 (step B5).

In the cellular phone 10, the Bluetooth communication unit 23 receives the electric current data transmitted from the electronic timepiece 30, and the CPU 11 obtains the electric current data of the electronic timepiece 30.

### [Fourth Step]

Next, in the cellular phone 10, the CPU 11 analyzes the increase/decrease pattern of the electric current data of the cellular phone 10 stored in step A4 and the increase/decrease pattern of the electric current data transmitted from the electronic timepiece 30 (step A5).

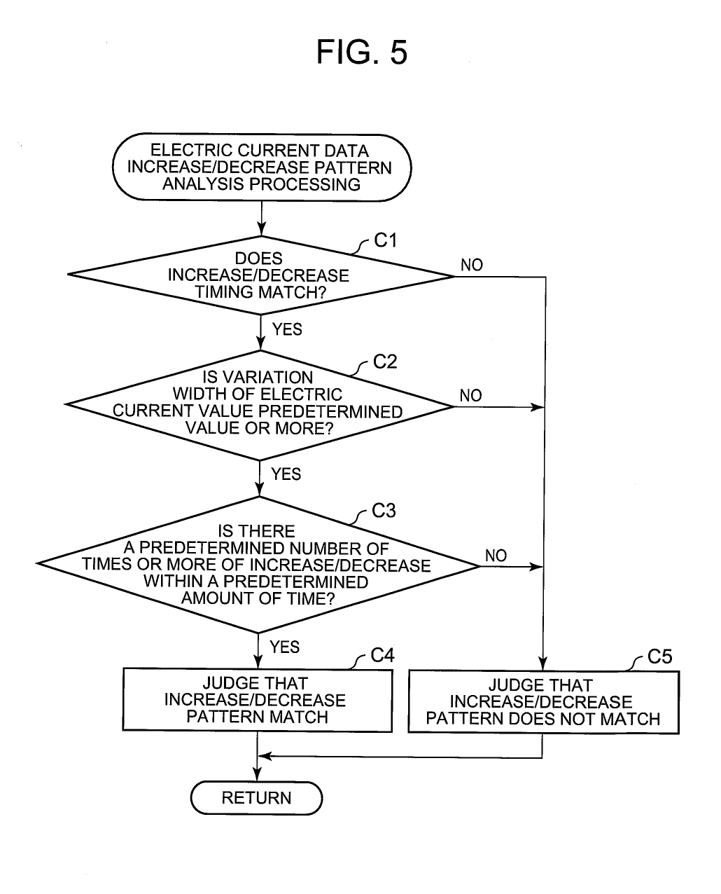

Here, the electric current data increase/decrease pattern analysis processing executed in the cellular phone 10 is described with reference to FIG. 5.

First, the CPU 11 compares the time series data of the electric current value (electric current data) corresponding to the receiving light amount detected by the light receiving sensor 18 with the time series data of the electric current value (electric current data) corresponding to the receiving light amount detected by the solar panel 38 which are to be targets of comparison. With this, the CPU 11 judges whether the increase/decrease timing matches (step C1). It is considered that “the increase/decrease timing match” when the terms (time range) that the electric current value increases and the terms that the electric current value decreases match respectively in both pieces of electric current data.

The electric current value being substantially a certain value (including being a certain value) in both pieces of electric current data is included as a case where the “increase/decrease timing match”.

In practice, the positions of the receiving light sensor 18 and the solar panel 38 are relatively different from the palm of the hand when the user moves the palm of the hand. Therefore, there is a possibility that a lag in time occurs in the change of the electric current value.

Therefore, when the match of the increase/decrease timing is judged between the two pieces of electric current data, it is possible to judge the match with a predetermined margin to consider the difference in increase/decrease timing due to difference of the time that the palm of the hand passes above the devices.

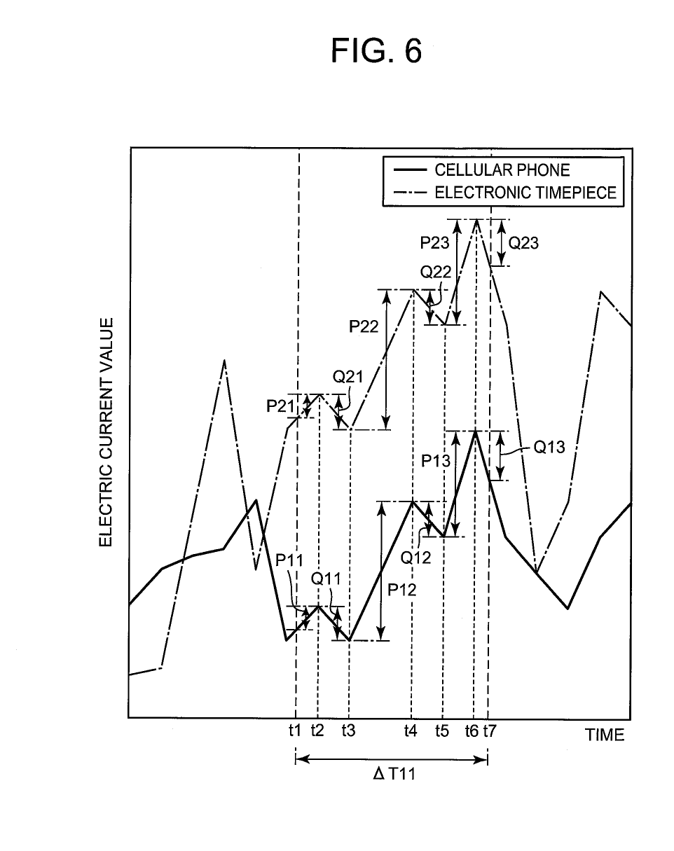

FIG. 6 shows an example of electric current data (solid line) obtained by the light receiving sensor 18 of the cellular phone 10 and electric current data (alternate long and short dash line) obtained by the solar panel 38 of the electronic timepiece 30.

In FIG. 6, the horizontal axis is the time and the vertical axis is the electric current value. In both pieces of electric current data, the electric current increases from time t1 to time t2, decreases from time t2 to time t3, increases from time t3 to time t4, decreases from time t4 to time t5, increases from time t5 to time t6, and decreases from time t6 to time t7.

In other words, the increase/decrease timing (electric current waveform pattern) in both pieces of electric current data match in the term ΔT11.

Since the electric current value according to the receiving light amount is different between the light receiving sensor 18 and the solar panel 38, the magnitude of the electric current value is different, however, the shape showing the change of the increase and decrease throughout time (timing that the value reaches the maximum value or the minimum value) match.

When the increase/decrease timing between the electric current data obtained by the light receiving sensor 18 and the electric current data obtained by the solar panel 38 match in step C1 (step C1; YES), the CPU 11 judges whether variation width of the electric current value (corresponding to the receiving light amount) included in each piece of electric current data is a predetermined value or more (step C2).

The variation width of the electric current value included in the electric current data is the difference between the maximum value and the minimum value of the electric current value included in the electric current data.

According to judgment in C2, it is possible to remove cases where the electric current value (receiving light amount) is substantially a constant value even when the increase/decrease timing between the pieces of electric current data match. The “predetermined value” which is to be a standard for comparison of the variation width of the electric current value is set in advance to a value suitable for judging whether the electric current value (receiving light amount) is substantially a constant value.

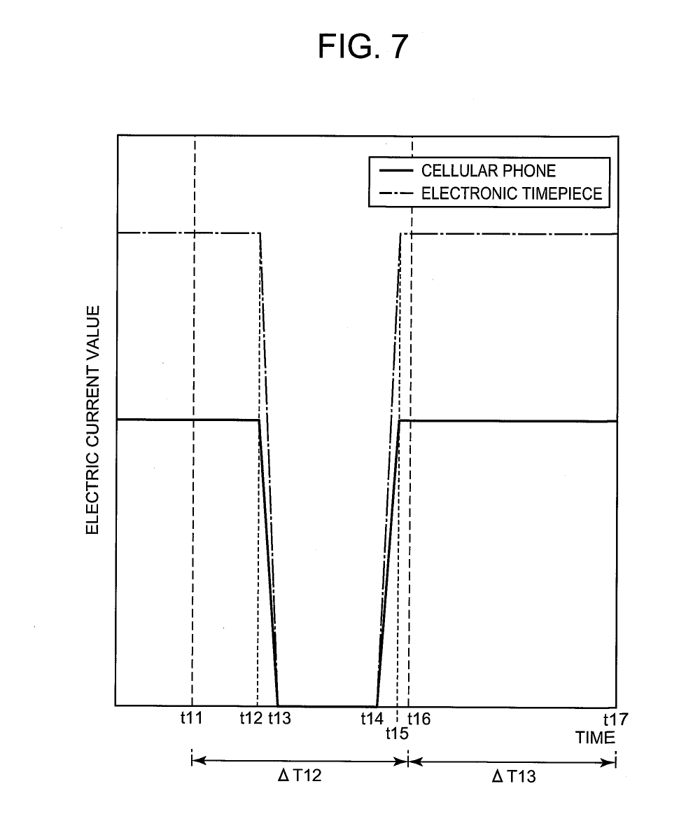

FIG. 7 shows an example where even if the increase/decrease timing of the electric current value between the electric current data (solid line) obtained by the light receiving sensor 18 of the cellular phone 10 and the electric current data (alternate long and short dash line) obtained by the solar panel 38 of the electronic timepiece 30 match, this is not considered to be the same change in pattern.

In FIG. 7, the horizontal axis is the time and the vertical axis is the electric current value.

In both pieces of electric current data, the electric current value from time t16 to time t17 is a constant value and the increase/decrease timing (electric current waveform pattern) of both pieces of electric current data match in the term ΔT13.

However, in the term ΔT13, the electric current value is a constant value and does not change.

In other words, in the term ΔT13, it is assumed that a state where the light from the light source to the light receiving sensor 18 and the solar panel 38 is constantly not shielded continues.

Therefore, it is considered that the increase/decrease pattern of both pieces of electric current data do not match when the electric current value is substantially a constant value.

In step C2, when the variation width of the electric current value included in the electric current data obtained by the light receiving sensor 18 and the variation width of the electric current value included in the electric current data obtained by the solar panel are each a predetermined value or more (step C2; YES), the CPU 11 judges whether the number of times that there is the increase and decrease in a predetermined amount or more within a predetermined amount of time (for example, two seconds) is a predetermined number of times (for example, three times) or more (step C3) in the electric current data obtained by the light receiving sensor 18 and the electric current data obtained by the solar panel 38.

The increase in a predetermined amount or more is when the amount of increase (variation amount) in a monotonic increase of a string of electric current data is a predetermined amount or more.

The decrease in a predetermined amount or more is when the amount of decrease (absolute value of variation amount) in a monotonic decrease of a string of electric current data is a predetermined amount or more.

According to judgment in step C3, it is possible to remove cases where the number of times that a significant increase or decrease in the electric current value based on intentional motion by the user occurs is less than a predetermined number of times even if the increase/decrease timing between the pieces of electric current data match.

The “predetermined amount of time”, “predetermined amount”, “predetermined number of times”, used in judgment of step C3 is set in advance to a suitable value for detecting the intentional motion by the user.

For example, in the electric current data obtained by the light receiving sensor 18 of the cellular phone 10 shown in FIG. 6, increase amount P11 from time t1 to time t2, decrease amount Q11 from time t2 to time t3, increase amount P12 from time t3 to time t4, decrease amount Q12 from time t4 to time t5, increase amount P13 from time t5 to time t6, and decrease amount Q13 from time t6 to time t7 are a predetermined amount or more.

Similarly, in the electric current data obtained by the solar panel 38 of the electronic timepiece 30, increase amount P21 from time t1 to time t2, decrease amount Q21 from time t2 to time t3, increase amount P22 from time t3 to time t4, decrease amount Q22 from time t4 to time t5, increase amount P23 from time t5 to time t6, and decrease time Q23 from time t6 to time t7 are a predetermined amount or more.

In the above case, it is judged that the increase in a predetermined amount or more occurs three times within a predetermined amount of time ΔT11 and the decrease in a predetermined amount or more occurs three times within a predetermined amount of time ΔT11 in the electric current data obtained by the light receiving sensor 18 of the cellular phone 10 and the electric current data obtained by the solar panel 38 of the electronic timepiece 30.

Turning to FIG. 7, both pieces of electric current data show that in term ΔT12, the value is constant from time t11 to time t12, there is a decrease from time t12 to time t13, the value is constant from time t13 to time t14, there is an increase from time t14 to time t15, and the value is constant from time t15 to time t16.

In other words, the increase/decrease timing (electric current waveform pattern) between both pieces of electric current data match in the term ΔT12.

However, it is assumed that both pieces of electric current data in term ΔT12 show that the action is not for the purpose of pairing the devices, and such data is obtained by temporarily turning off the interior lighting and then tuning it on again.

In both pieces of electric current data, the increase and decrease within a predetermined amount of time ΔT12 is once each, and this is less than the predetermined number of times (for example, three times) of increase or decrease within a predetermined amount of time ΔT12. Therefore, this is removed from the match of the increase/decrease pattern.

In step C3, when the increase in a predetermined amount or more occurs a predetermined number of times or more within a predetermined amount of time and the decrease in a predetermined amount or more occurs a predetermined number of times or more within a predetermined amount of time in each piece of the electric current data obtained by the light receiving sensor 18 and the electric current data obtained by the solar panel 38 (step C3; YES), the CPU 11 judges that the increase/decrease pattern of the electric current data obtained by the light receiving sensor 18 and the increase/decrease pattern of the electric current data obtained by the solar panel 38 match (step C4).

When the increase/decrease timing between the electric current data obtained by the light receiving sensor 18 and the electric current data obtained by the solar panel 38 do not match in step C1 (step C1; NO), when the variation width of the electric current value included in either of the electric current data obtained by the light receiving sensor 18 or the electric current data obtained by the solar panel 38 is less than a predetermined value in step C2 (step C2; NO), and when the number of times that the increase in a predetermined amount or more occurs within the predetermined amount of time is less than a predetermined number of times or when the number of times that the decrease in a predetermined amount or more occurs within the predetermined amount of time is less than a predetermined number of times in either of the electric current data obtained by the light receiving sensor 18 or the electric current data obtained by the solar panel 38 in step C3 (step C3; NO), the CPU 11 judges that the increase/decrease pattern of the electric current data obtained by the light receiving sensor 18 and the increase/decrease pattern of the electric current data obtained by the solar panel 38 do not match (step C5).

After step C4 or step C5, the electric current data increase/decrease pattern analysis processing ends.

When the match of the increase/decrease timing is judged in step C1, the increase/decrease timing does not have to match throughout the entire range in both pieces of electric current data which are the target of comparison. It is enough if there is a term where the increase/decrease timing match.

Then, the above term in which the increase/decrease timing match becomes the target of the judgments of step C2 and step C3.

Returning to FIG. 4, when it is judged that the increase/decrease pattern of the electric current data of the cellular phone 10 and the increase/decrease pattern of the electric current data of the electronic timepiece 30 match in the electric current data increase/decrease pattern analysis processing (step A6; YES), the CPU 11 of the cellular phone 10 transmits a signal instructing pairing to the electronic timepiece 30 through the Bluetooth communication unit 23 (step A7).

In the electronic timepiece 30, when the Bluetooth communication unit 40 receives the signal instructing pairing from the cellular phone 10, the CPU 31 transmits a signal in response to the pairing instruction through the Bluetooth communication unit 40 to the cellular phone 10 (step B6).

Then, the CPU 31 sets the cellular phone 10 as the communication partner of the electronic timepiece 30.

For example, the CPU 31 stores in the storage unit 34 identification information of the cellular phone 10 obtained from the cellular phone 10 as the target device to perform Bluetooth communication.

In the cellular phone 10, when the Bluetooth communication unit 23 receives the signal in response to the pairing instruction from the electronic timepiece 30, the CPU 11 sets the electronic timepiece 30 as the communication partner of the cellular phone 10.

For example, the CPU 11 stores in the storage unit 14 identification information of the electronic timepiece 30 obtained from the electronic timepiece 30 as the target device to perform Bluetooth communication.

With this, the pairing between the cellular phone 10 and the electronic timepiece 30 is completed.

On the other hand, when it is judged in the electric current data increase/decrease pattern analysis processing that the increase/decrease pattern of the electric current data of the cellular phone 10 and the increase/decrease pattern of the electric current data of the electronic timepiece 30 do not match (step A6; NO), the CPU 11 of the cellular phone 10 transmits a signal to instruct that pairing is not possible through the Bluetooth communication unit 23 to the electronic timepiece 30 (step A8).

In the electronic timepiece 30, when the Bluetooth communication unit 40 receives a signal to instruct that pairing is not possible from the cellular phone 10, the CPU 31 transmits a signal in response to the instruction that pairing is not possible through the Bluetooth communication unit 40 to the cellular phone 10 (step B6).

Alternatively, in the electronic timepiece 30, the CPU 31 can judge that pairing with the cellular phone 10 is not possible when the Bluetooth communication unit 40 does not receive a signal to instruct pairing or a signal to instruct that pairing is not possible from the cellular phone 10.

Next, in the cellular phone 10, the CPU 11 allows the display unit 17 to display the pairing state (step A9).

Specifically, when the pairing with the electronic timepiece 30 is completed, the CPU 11 displays that the pairing is completed, whereas when the pairing with the electronic timepiece 30 fails, the CPU 11 displays that the pairing failed.

Similarly, in the electronic timepiece 30, the CPU 31 allows the display unit 37 to display the pairing state (step B7).

Specifically, when the pairing with the cellular phone 10 is completed, the CPU 31 displays that the pairing is complete, whereas when the pairing with the cellular phone 10 fails, the CPU 31 displays that the pairing failed.

As described above, the cellular phone 10 and the electronic timepiece 30 are paired based on the electric current data (corresponding to time series data of the receiving light amount) obtained by the light receiving sensor 18 of the cellular phone 10 and the electric current data (corresponding to the time series data of the receiving light amount) obtained by the solar panel 38 of the electronic timepiece 30.

After the pairing is established, bidirectional communication by Bluetooth communication is performed between the cellular phone 10 and the electronic timepiece 30.

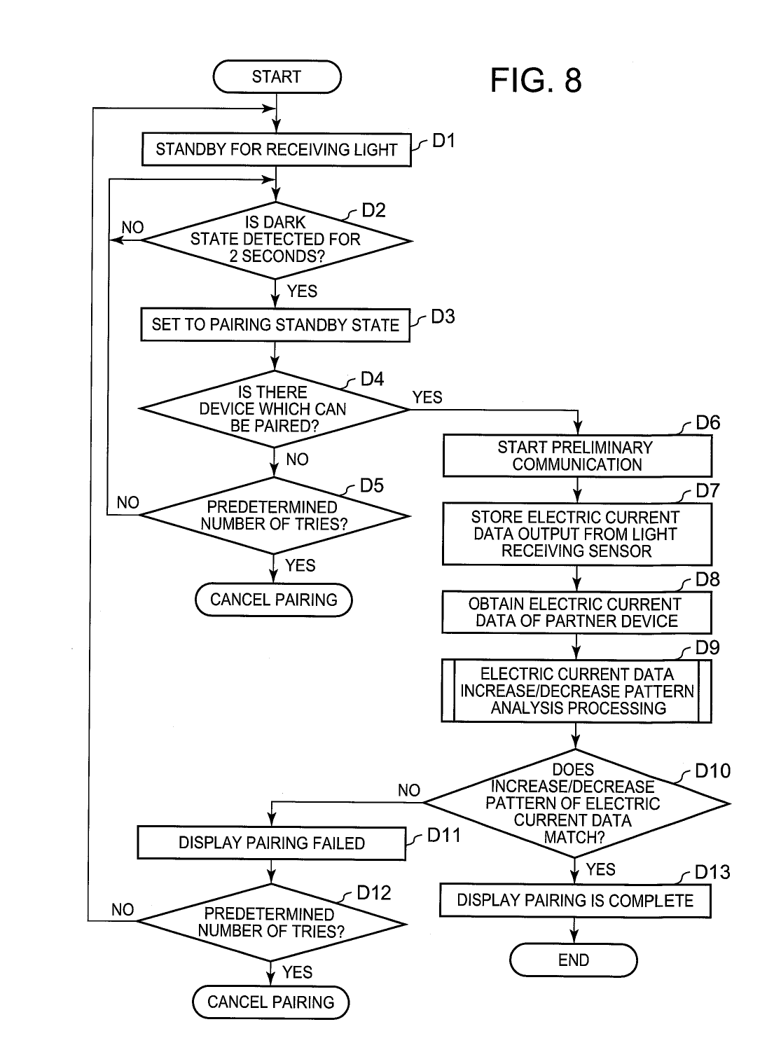

FIG. 8 is a flowchart showing the pairing processing executed in the cellular phone 10.

First, the CPU 11 controls the light receiving sensor 18 to be set to a light receiving standby state which can detect receiving light amount (step D1).

Next, the CPU 11 obtains time series data (electric current data) of electric current value corresponding to the receiving light amount detected in the light receiving sensor 18, and judges whether a state where the light receiving sensor 18 is shielded (dark state) continues for two seconds (step D2).

When the state that the light receiving sensor 18 is shielded continues for two seconds (step D2; YES), the CPU 11 sets the cellular phone 10 in the pairing standby state (step D3).

Next, the CPU 11 attempts detection of another electronic device with which pairing is possible (step D4).

When another electronic device with which pairing is possible is not detected (step D4; NO), the CPU 11 judges whether the processing of step D4 is tried a predetermined number of times (step D5).

When the processing of step D4 is tried a predetermined number of times (step D5; YES), the CPU 11 cancels the pairing.

When the processing of step D4 is not tried a predetermined number of times (step D5; NO) or when the state that the light receiving sensor 18 is shielded does not continue for two seconds in step D2 (step D2; NO), the processing returns to step D2.

In step D4, when another electronic device with which pairing is possible is detected (step D4; YES), the CPU 11 starts preliminary communication with the detected electronic device (electronic timepiece 30) (step D6).

Here, the user changes the intensity of light on the light receiving sensor 18 of the cellular phone 10 and the solar panel 38 of the electronic timepiece 30 with which pairing is desired under the same light receiving environment.

Specifically, the user moves the palm of the hand back and forth so as to shield the light on the light receiving portion of the light receiving sensor 18 and the solar panel 38 a plurality of times.

The CPU 11 stores in the storage unit 14 the time series data of the electric current value (electric current data) corresponding to the receiving light amount detected by the light receiving sensor 18 when the light intensity is changed (step D7).

Next, in the cellular phone 10, the CPU 11 obtains from the partner device the time series data of the electric current value (electric current data) corresponding to the receiving light amount detected by the solar panel 38 of the partner device (electronic timepiece 30) when the light intensity is changed through the Bluetooth communication unit 23 (step D8).

The CPU 11 analyzes the increase/decrease pattern of the electric current data of the cellular phone 10 and the increase/decrease pattern of the electric current data of the electronic timepiece 30 when the light intensity is changed (step D9).

The electric current data increase/decrease analysis processing is described above with reference to FIG. 5.

When the CPU 11 judges that the increase/decrease pattern of the electric current data of the cellular phone 10 and the increase/decrease pattern of the electric current data of the electronic timepiece 30 do not match (step D10; NO), the CPU 11 transmits the signal instructing that pairing is not possible through the Bluetooth communication unit 23 to the electronic timepiece 30.

Then, the CPU 11 allows the display unit 17 to display that the pairing failed (step D11).

Next, the CPU 11 judges whether the processing of step D10 is tried a predetermined number of times (step D12).

When the processing of step D10 is tried a predetermined number of times (step D12; YES), the CPU 11 cancels the pairing.

When the processing of step D10 is not tried a predetermined number of times (step D12; NO), the processing returns to step D1.

In step D10, when it is judged that the increase/decrease pattern of the electric current data of the cellular phone 10 and the increase/decrease pattern of the electric current data of the electronic timepiece 30 match (step D10; YES), the CPU 11 transmits a signal to instruct pairing through the Bluetooth communication unit 23 to the electronic timepiece 30.

Then, when the Bluetooth communication unit 23 receives the signal in response to the pairing instruction from the electronic timepiece 30, the CPU 11 sets the electronic timepiece 30 as the communication partner of the cellular phone 10. The CPU 11 allows the display unit 17 to display that the pairing is completed (step D13).

With this, the pairing processing executed in the cellular phone 10 ends.

As described above, according to the present embodiment, in the first step, the cellular phone 10 and the electronic timepiece 30 are set to the pairing standby state.

Next, in the second step, the light intensity on the light receiving sensor 18 of the cellular phone 10 and the solar panel 38 of the electronic timepiece 30 is changed under the same light receiving environment.

Next, in the third step, the time series data (electric current data) of the receiving light amount detected by the solar panel 38 of the electronic timepiece 30 in the second step is transmitted from the electronic timepiece 30 to the cellular phone 10.

Next, in the fourth step, the cellular phone 10 and the electronic timepiece 30 are paired based on the time series data (electric current data) of the receiving light amount detected by the light receiving sensor 18 of the cellular phone 10 and the time series data (electric current data) of the receiving light amount transmitted from the electronic timepiece 30 in the second step.

For example, it is possible for two electronic devices which are to be communication partners to acknowledge each other by a simple operation, for example, by moving the palm of the hand so that the palm of the hand passes back and forth above the light receiving unit (light receiving sensor 18, solar panel 38) of both devices a plurality of times in a state where the cellular phone 10 and the electronic timepiece 30 are adjacent to each other.

Therefore, even when there are a plurality of electronic devices within the accessible range of the radio wave, it is possible to pair specific electronic devices with a simple method.

The electronic devices are paired by analyzing the time series data (electric current pattern) of the receiving light amount. Therefore, the pairing is not limited to the same product (devices) of a same manufacturer or products with the same format, and it is possible to easily pair products of different manufacturers.

In the fourth step, it is judged whether the increase/decrease pattern of the electric current data of the cellular phone 10 and the increase/decrease pattern of the electric current data of the electronic timepiece 30 match, and when it is judged that the increase/decrease pattern of both pieces of data match, the cellular phone 10 and the electronic timepiece 30 are paired.

Since the increase/decrease pattern of the electric current data of the cellular phone 10 and the increase/decrease pattern of the electric current data of the electronic timepiece 30 match, it is possible to judge that both devices are under the same light receiving environment, and it is possible to easily select the electronic devices to be paired.

On the other hand, it is possible to prevent undesired pairing of electronic devices.

In the fourth step, when the variation width of the electric current value (receiving light amount) included in the electric current data of the cellular phone 10 or the electric current data of the electronic timepiece 30 is less than a predetermined value, it is judged that the increase/decrease pattern of the electric current data of the cellular phone 10 and the increase/decrease pattern of the electric current data of the electronic timepiece 30 do not match. Therefore, it is possible to prevent false operation such as preventing undesired pairing of electronic devices.

In the fourth step, when the number of times of the increase or decrease in a predetermined amount or more within a predetermined amount of time is less than a predetermined number of times in the electric current data of the cellular phone 10 or the electric data of the electronic timepiece 30, it is judged that the increase/decrease pattern of the electric current data of the cellular phone 10 and the increase/decrease pattern of the electric current data of the electronic timepiece 30 do not match. Therefore, it is possible to prevent false operation such as undesired pairing of electronic devices.

In the first step, the cellular phone 10 and the electronic timepiece 30 are set to a pairing standby state by providing a predetermined light receiving environment condition (shielding state of two seconds) on the light receiving sensor 18 of the cellular phone 10 and the solar panel 38 of the electronic timepiece 30. Therefore, the user does not have to perform mechanical operation such as pressing buttons on the electronic device.

The description of the above described embodiment is one example of the pairing method of the present invention, and the present invention is not limited to the above.

The detailed configuration and the detailed operation of each unit of each device in each processing step can be suitably modified without leaving the scope of the present invention.

For example, according to the present embodiment, the intensity of light which the light receiving unit receives is changed by moving the palm of the hand so as to shield the light receiving unit with the palm of the hand. However, it is possible to change the light intensity by emitting (increasing the receiving light amount) light from a light source such as an LED (Light Emitting Diode) light, etc. to the light receiving units.

Alternatively, it is possible to change the light intensity by repeating the switching of on and off of the interior lighting in the room a plurality of times within a predetermined amount of time.

According to the present embodiment, in the second step, the palm of the hand is moved back and forth a plurality of times above the light receiving unit of both devices. However, similar to the start of the pairing mode, it is possible to pair the devices when the light receiving unit of both devices are shielded continuously for a predetermined amount of time.

Alternatively, it is possible to change the light intensity by moving the palm of the hand closer and farther from the light receiving unit of both devices.

Alternatively, the light from the light source can be shielded using a device, and such process is not limited to using the palm of the hand.

According to the present embodiment, in step C3, it is considered that there is a substantial increase or decrease when the increase amount or decrease amount is a predetermined amount or more. However, it is possible to judge the match of the increase/decrease pattern of the time series data of the receiving light amount based on the match of timing of repeating a state where the value is equal to or more than a first threshold and a state where the value is equal to or less than a second threshold (second threshold<first threshold) when the time series data (electric current data) of the receiving light amount obtained from both devices are compared. The thresholds are determined in advance according to the range of the receiving light amount of each device.

Alternatively, it is possible to provide a threshold to judge whether the light from the light source is shielded and to judge the match of the increase/decrease pattern of the time series data of the receiving light amount based on the match of timing that the receiving light amount becomes equal to or less than this threshold.

According to the above embodiment, the time series data (electric current data) of the electric current value corresponding to the receiving light amount is used as the time series data of the receiving light amount. However, any value can be used as long as it is a value corresponding to the receiving light amount.

According to the present embodiment, the light receiving unit is shielded with the palm of the hand for two seconds to act as a trigger to set the devices to the pairing standby state. However, the user can perform other operation such as pressing a button provided on the cellular phone 10 and the electronic timepiece 30 to set the devices to the pairing standby state.

According to the above embodiment, the light receiving sensor 18 and the solar panel 38 are used as the light receiving units. However, the present invention is not limited to the above.

For example, when the cellular phone 10 includes a camera, the camera can be used as the light receiving element, or when the cellular phone 10 includes a solar panel, the solar panel can be used as the light receiving element.

When the electronic devices are paired, it is possible to use the motion of shielding the light receiving unit from the light source to operate the partner device.

For example, after the cellular phone 10 and the electronic timepiece 30 are paired, it is possible to set the devices so that the reception of phone calls to the cellular phones 10 are connected or cut when the light intensity is changed by, for example, shielding the light from the light source on the solar panel 38 of the electronic timepiece 30 a predetermined number of times.

Bluetooth is provided as an example of a communication method between electronic devices, however, the method is not limited to the above.

For example, infrared communication, UWB (Ultra Wide Band), etc. may be used.

Although various exemplary embodiments have been shown and described, the invention is not limited to the embodiments shown. Therefore, the scope of the invention is intended to be limited solely by the scope of the claims that follow and its equivalents.

The entire disclosure of Japanese Patent Application No. 2013-060155 filed on Mar. 22, 2013 including specification, claims, drawings and abstract are incorporated herein by reference in its entirety.

What is claimed is:

1. A pairing method which pairs a first electronic device with a second electronic device, each electronic device including a communication unit to communicate data and a light receiving unit to detect receiving light amount, the method comprising:
setting the first electronic device and the second electronic device to a pairing standby state;
changing light intensity on the light receiving unit of the first electronic device and the light receiving unit of the second electronic device under a same light receiving environment;
transmitting from the second electronic device to the first electronic device time series data of receiving light amount detected by the light receiving unit of the second electronic device in the changing of the light intensity; and
pairing the first electronic device with the second electronic device based on time series data of receiving light amount detected by the receiving light unit of the first electronic device in the changing of the light intensity and the time series data of receiving light amount transmitted from the second electronic device.

2. The pairing method according to claim 1, wherein,
in the pairing of the electronic devices, it is judged whether an increase/decrease pattern of the time series data of the first electronic device matches with an increase/decrease pattern of the time series data of the second electronic device and when it is judged that both increase/decrease patterns match, the first electronic device is paired with the second electronic device.

3. The pairing method according to claim 2, wherein,
in the pairing of the electronic devices, when a variation width of receiving light amount included in the time series data of the first electronic device or the time series data of the second electronic device is less than a predetermined value, it is judged that the increase/decrease pattern of the time series data of the first electronic device does not match with the increase/decrease pattern of the time series data of the second electronic device.

4. The pairing method according to claim 2, wherein,
in the pairing of the electronic devices,
when a number of times of increase or decrease in a predetermined amount or more within a predetermined amount of time is less than a predetermined number in the time series data of the first electronic device or the time series data of the second electronic device, it is judged that the increase/decrease pattern of the time series data of the first electronic device does not match with the increase/decrease pattern of the time series data of the second electronic device.

5. The pairing method according to claim 3, wherein,
in the pairing of the electronic devices,
when a number of times of increase or decrease in a predetermined amount or more within a predetermined amount of time is less than a predetermined number in the time series data of the first electronic device or the time series data of the second electronic device, it is judged that the increase/decrease pattern of the time series data of the first electronic device does not match with the increase/decrease pattern of the time series data of the second electronic device.

6. The pairing method according to claim 1, wherein,
in the setting of the pairing standby state,
the first electronic device and the second electronic device are set to a pairing standby state when a predetermined light receiving environment condition is provided on the light receiving unit of the first electronic device and the light receiving unit of the second electronic device.

7. An electronic device comprising:
a communication unit which communicates data;
a light receiving unit which detects receiving light amount;
an obtaining unit which obtains from another electronic device time series data of receiving light amount detected in another electronic device at a same timing as detecting the receiving light amount with the light receiving unit; and
a pairing unit which pairs the electronic device with another electronic device based on time series data of receiving light amount detected by the light receiving unit and the time series data of receiving light amount obtained by the obtaining unit.
